(19) United States
(12) Patent Application Publication
(10) Pub. No.: US 2023/0149138 A1
(43) Pub. Date: May 18, 2023

(54) CHEEK RETRACTOR

(71) Applicant: Holger Zipprich, Malchen (DE)

(72) Inventor: Holger Zipprich, Malchen (DE)

(21) Appl. No.: 17/922,851

(22) PCT Filed: May 3, 2021
(86) PCT No.: PCT/EP2021/061603

§ 371 Date: Nov. 2, 2022

(30) Foreign Application Priority Data
May 3, 2020 (DE) 10 2020 002 627.3

(51) Int. Cl. A61C 17/10

(52) U.S. Cl. CPC A61C 17/10

(57) ABSTRACT

In order to improve the occupational safety of the treating personnel during a dental treatment of a patient, an apparatus is provided wherein the discharge of aerosols from the oral cavity during the dental treatment can be reduced to a particular extent or possibly completely prevented. To this end, a cheek retractor, in particular for holding the patient's mouth open during a dental treatment in the oral cavity or throat, is equipped with integrated suction, wherein a plurality of suction openings connected to a suction system are arranged on the lip support shell of the cheek retractor.

The invention relates to a cheek holder, in particular for keeping the patient's mouth open during treatment in the oral or pharyngeal region or dental treatment, with a lip retaining shell into which a part of the lip, for example in the corner of the mouth, can be inserted during treatment.

Cheek retractors of this type are often used during dental procedures or treatments to keep the patient's mouth open during treatment and thus facilitate the dentist's access to the oral cavity. Such a cheek retractor usually comprises a lip retaining shell into which a part of the lip can be inserted during the treatment. In a single-sided version of the cheek holder, for example, this can then be inserted into one corner of the patient's mouth so that it protects the lip and pulls the cheek away with traction on an integrally formed wan gen holder handle to increase access to the oral cavity. In contrast, double-sided cheek retractors are also common, in which two lip-retaining shells are connected to each other via an arch-shaped, usually slightly resilient connecting element. The lip retainer shells can be inserted into the two mouth angles, and the mouth angles are then pressed apart accordingly via the connecting element so that the mouth can be held open for treatment without the staff having to constantly apply traction or a holding force to the lip retainer shells by hand.

Cheek retractors are also known with a continuous lip retractor shell (also known as a “mouth prop” in English) which completely covers the patient's lips along the entire length or contour of the lips. These usually consist of an elastic base material which is more or less slightly deformed during insertion into the patient's mouth, i.e. when the lip is placed in the circumferential lip retainer shell, and then, after release by the dentist, holds the patient's mouth open due to the restoring forces.

During dental treatment, aerosols can be generated depending on the therapy and/or the therapy procedure used. These are usually aerosols with a high water content. For example, when drilling or grinding at high speeds, the drills or grinders must be cooled with a suitable cooling medium, usually water-based. In most cases, this cooling medium itself is an aerosol of air and water. But also due to the high speed of the drills or grinders of up to approx. 120,000 rpm, aerosols are formed from air, water, the detached substances (mostly tooth hard substance), but also hard & soft tissue and body fluids (saliva, blood, biofilm, etc.). Other methods even use aerosols (air-powder-water), which are intended to remove biofilms from teeth or dentures with pressure.

The dentist and his assistant usually try to extract the aerosols used or produced with a suction device. However, too much suction would have a negative effect on the use and effect of the aerosol or the water used for cooling. Consequently, it is very likely that the aerosols will not remain entirely in the oral cavity during such treatment, but will escape from the oral cavity or even spray out of the mouth. This poses a risk to the dentist, his assistant and anyone in the immediate vicinity of the treatment, as these aerosols do not sink directly to Bo den but remain in the air for a long time.

Professional dental cleanings (PZR) are performed very efficiently and very reliably with an air-powder-water spray. Here, an aerosol mixture of air, powder (mostly glycine particles) and water is used with a pressure to remove biofilms and plaque on teeth and dentures.

However, an aerosol of air and water is also used to cool the grinding process when grinding teeth. Among other things, cooling is necessary to protect the nerve inside the tooth and to prevent its damage. If the temperature of the nerve increases by approx. 5.5° C., it can already be damaged and even die.

This circumstance of aerosols and/or other droplets or splashes being released from the patient's oral cavity is unsatisfactory for reasons of hygiene as well as health protection for the treating personnel. Probably the greatest danger from aerosols leaving the oral cavity is the transmission of bacteria, viruses and fungi from person to person. Particularly in the current Covid-19 era, this point has taken on a new and crucial importance. The hygiene concepts of various institutions already prohibit therapies in which aerosols are released, regardless of whether these are themselves part of the therapy or merely arise as a byproduct of the therapy. In particular, the potential risk to staff from infection with the corona virus was considered too high. Such treatments may usually only be carried out with the wearing of an FFP-2 mask and a face visor, if at all.

In occupational medicine and occupational safety, the first approach considered in this respect is to avoid the hazard by eliminating the source of the hazard. This can be implemented with a treatment ban. However, it follows from this that many necessary treatments cannot or must not be carried out. Although the non-performance of necessary therapies protects the treating staff, it usually leads to a deterioration of the patient's oral health. In addition, the resulting delay in treatment often means that an originally comparatively simple therapy has to be carried out at a later date, which is much more time-consuming, involves a higher risk for the success of the treatment, and is also much more cost-intensive.

Another way of avoiding the above-mentioned risk would be to select another, alternative therapy procedure in which no aerosols are released. However, with regard to a PZR, for example, at best inferior therapy procedures would be available, and no adequate procedures are available for grinding teeth.

The second stage of preventing a hazard in occupational safety is to physically separate the source of the hazard from the employee, and the third stage would be the use of personal protective equipment (PPE) such as the use of mouth and nose protection, goggles/visors and gloves. However, the use of standard PPE during dental procedures does not give 100% protection against the transmission of corona viruses to the treating personnel.

The invention is therefore based on the task of specifying a device, in particular for improving the occupational safety of the treating personnel, with which the escape of aerosols from the oral cavity during the treatment of a patient can be reduced to a particular extent or possibly completely avoided.

This task is solved in accordance with the invention by means of a cheek holder of the type mentioned above, on whose lip retaining shell a number of suction openings connected to an extraction system are arranged.

The invention is based on the idea that, in view of the unsatisfactory protective effect of conventional PPE, particularly in the case of an increased need for protection, for example against infection with the corona virus, the second stage of avoiding hazards in occupational health and safety should be consistently pursued in order to reduce or, if possible, completely prevent the transmission of bacteria, viruses and fungi to the treating personnel. To this end, it is considered desirable to avoid or minimize aerosols leaving the oral cavity at all. In principle, this could be achieved by extensive or complete extraction of the aerosols directly at the point of origin, i.e. inside the oral cavity, but this could on the other hand have negative effects on the efficiency of the desired therapy, so that this is not considered to be sensible. Any additional suction to be introduced into the oral cavity would also massively restrict the view of the treatment itself and the already severely limited space for performing the therapy itself Therefore, suction of the aerosols should be provided in the exit area from the oral cavity, i.e. in particular in the area of the lip pontour of the patient.

In order to make this possible in a particularly simple and thus efficient manner, the provision of a suction unit suitable for the removal of aerosols is envisaged, with recourse to an instrument which is already frequently used in dental treatments. Accordingly, a cheekpiece holder of the type mentioned above should be suitably equipped for such a suction system. In the sense of the invention, the cheek holder thus serves in the manner of a carrier element to arrange the suction openings of the suction system in a position considered particularly suitable for this purpose, namely, according to the invention, in direct or at least extensive spatial proximity to the lip contour of the patient.

The suction system advantageously comprises a pump or suction unit which is suitably selected, in particular with regard to the suction power, and which is connected to a suction channel system which in turn opens into the suction openings mentioned. The end channel segment of this channel system, i.e. in particular the end channel section opening into the suction openings, is advantageously integrated in the cheek holder. The suction openings, in turn, are designed and positioned in a particularly partial configuration for particularly effective suction of the respiratory or air stream flowing out of the patient's oral cavity; accordingly, they point particularly preferably in the direction of the patient's oral cavity when the cheek retractor is inserted.

In order to ensure particularly effective suction of the exhaust gases from the oral cavity, the suction openings should be positioned particularly close to the mouth opening defined by the lips or lip contour. In order to take this into account, in a further particularly advantageous embodiment the suction openings are positioned at a maximum of 25 mm, preferably at a maximum of 20 mm, particularly preferably at a maximum of 10 mm, offset from the parting plane between the so-called “intraoral” or inner region of the oral cavity and the so-called “extraoral” or outer region of the oral cavity. The so-called “separation plane” corresponds largely to the plane of the mouth opening itself.

Along the lip contour or the “lip section”, defined here as the total section formed by the section resulting from the patient's upper lip and the section resulting from his lower lip, several positioning options for suitably selected suction holes are conceivable. Desirable and particularly preferred is an approach in which the entire length of the patient's lip is provided with aspiration holes of the type mentioned. However, it may seem impossible to provide the entire length of the patient's lips with suction holes, in particular because of the usually very individual and different lip lengths of different patients. Advantageously, however, at least 25%, preferably at least 50%, and in a particularly preferred embodiment at least 75% of the lip section is provided with an associated suction or suction openings.

In a particularly preferred further development of the invention, account is taken of the fact that the treating personnel usually wear gloves during treatment. These could be inadvertently sucked in via the suction openings and thus hinder the personnel in handling. To counteract this in a particularly simple and reliable manner, the cheek holder should be designed to prevent or at least minimize direct surface contact of gloves or fingers with the actual air passage surface of the suction openings. For this purpose, in a particularly preferred embodiment of the cheek holder which is also considered to be independently inventive, spacers or spacer ribs are provided in the vicinity of the intake holes. The result of these is that, at least when the gloves fit very snugly on the hands, the gloves cannot have direct contact with the suction openings.

In another particularly preferred design, the fact that a wide variety of media are introduced into the oral cavity during the underlying treatment of the patient, in particular during dental cleaning (PZR), is also taken into account. In order to ensure reliable suction, especially of aerosols, it is considered particularly advantageous if the suction line or the suction volume is at least as high as the volume of liquids, gases and solids introduced into the oral cavity, usually in the form of air, water and powder (in the case of a PZR), if possible in total with the suction line or the suction volume of the additional suction instruments that may be introduced. In addition, the patient's exhaled volume can also be included in the calculation of the minimum necessary aspiration volume. However, it is usually the case that during the introduction of liquid, gases and or solids (e.g. cooling during grinding, air-powder-water spray [PZR], air-water mixture, air, etc.), the patient closes the pharynx with the tongue and breathes through the nose to avoid swallowing the introduced media. Taking these aspects into account, the preferred suction volume, i.e. the suction volumetric flow, and thus the selected suction power of the suction system should be at least 120%, preferably at least 150% and, in a particularly preferred embodiment, 200% of the volumetric flow of the introduced media. In a particularly preferred embodiment, which is considered to be independently inventive, the suction system and in particular the suction pump assigned to it is designed for a suction capacity of at least 400 l/min, particularly preferably of at least 500 l/min, very especially preferably of at least 750 l/min.

The advantages achieved with the invention consist in particular in the fact that by providing a dental cheek holder with suction attached to it or integrated therein, the release of aerosols from the oral cavity during or as a result of treatment can be largely or possibly even completely prevented or avoided. This ensures that there is no, or at most very little, transmission of bacteria, viruses or fungi to the treating personnel. For this purpose, the cheek retractor has a number of suction openings through which the aerosols can be extracted. The suction openings are arranged along the length of the lips to enable the oral cavity to be suctioned as evenly as possible.

During a PZR and dental treatment, the instruments that introduce air, water and aerosol orally and the corresponding suction instruments are not started and switched off at the same time. In dental treatment in particular, the instruments that introduce air, water and aerosol are controlled (started and stopped) by the dentist and the suction instruments are controlled by the dental assistant. Under time pressure, this often results in the suction being started with a slight delay and also being stopped again before all the aerosols present in the patient's mouth have been suctioned off. In the present invention, it is particularly worth mentioning that the suction system attached to or integrated in the cheek retractor is independent of the activities of the operator and the assistant. Thus, the suction can be started ahead of time and operated for a short time longer for suction after all instruments have been removed from the oral cavity. This avoids or prevents unwanted aerosol escapes from the oral cavity.

An embodiment of the invention is explained in more detail with reference to a drawing. Therein show:

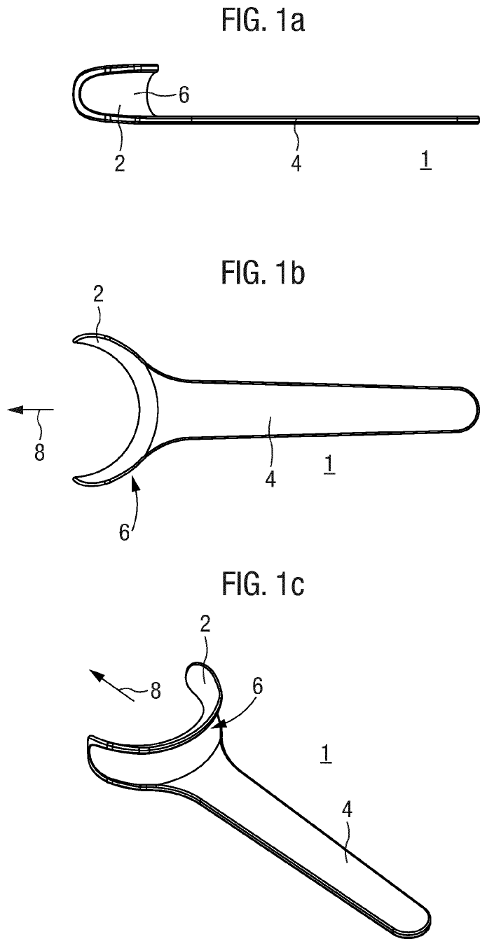

FIG. 1 a cheek piece holder of conventional design in a one-sided version in top view (FIG. 1a), in side view (FIG. 1b), and in perspective view (FIG. 1c),

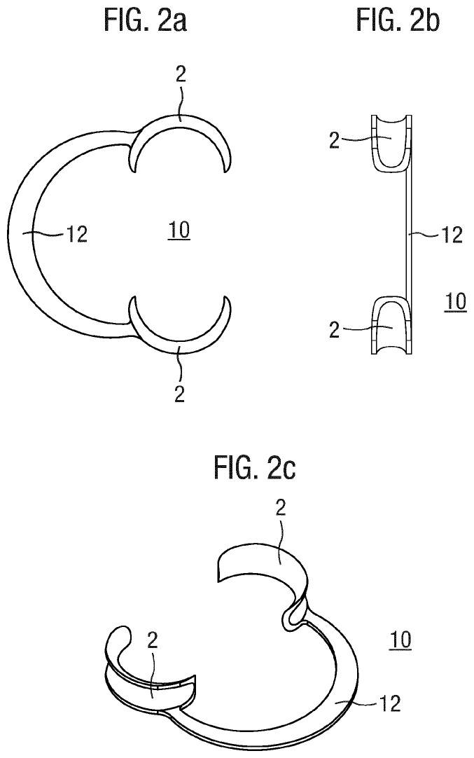

FIG. 2 a stringer holder of conventional design in double-sided design in top view (FIG. 2a), in side view (FIG. 2b), and in perspective view (FIG. 2c),

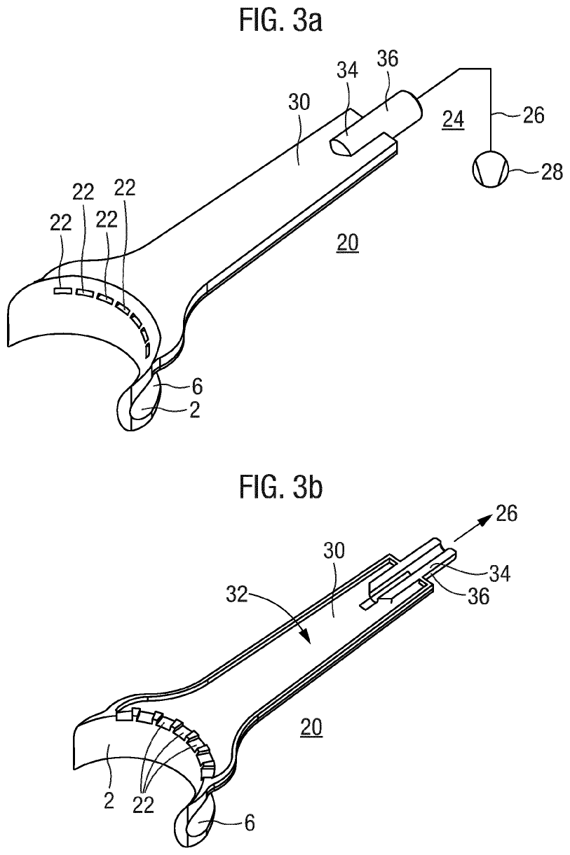

FIG. 3A cheek holder with integrated suction system in a single-sided design in perspective view (FIG. 3a) and perspective section (FIG. 3b),

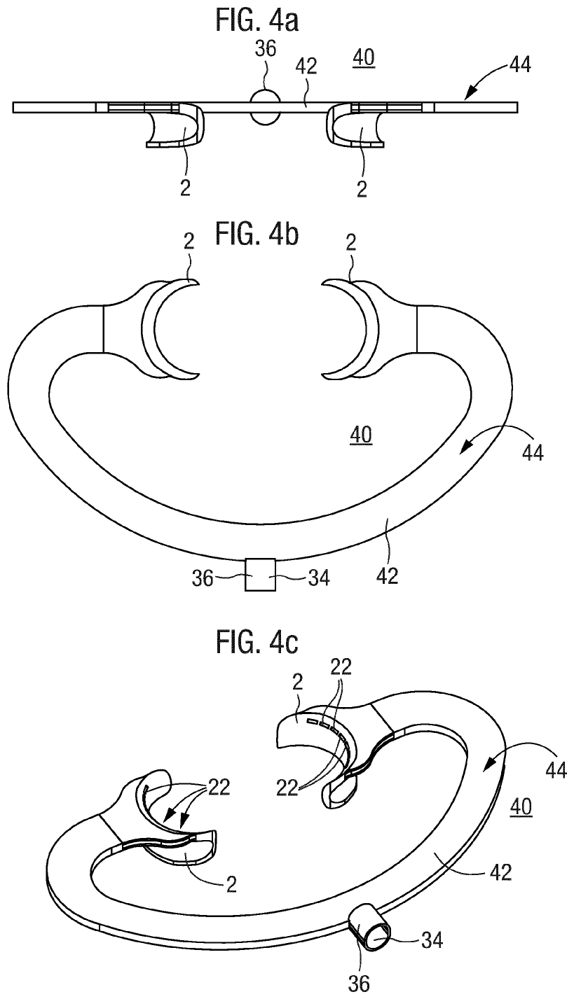

FIG. 4 a cheek holder with integrated suction system in double-sided design in lateral (FIG. 4a) and perspective view (FIG. 4b),

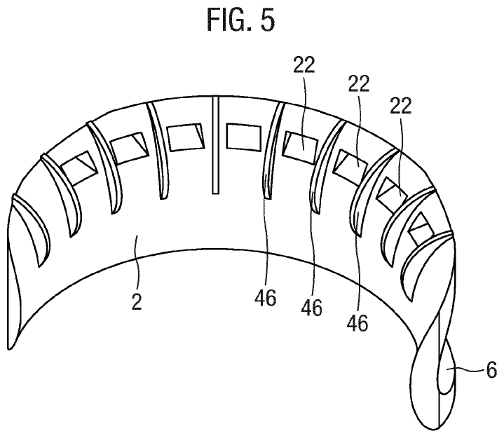

FIG. 5a lip retainer, in particular for use in a cheek retainer according to FIG. 3 or 4,

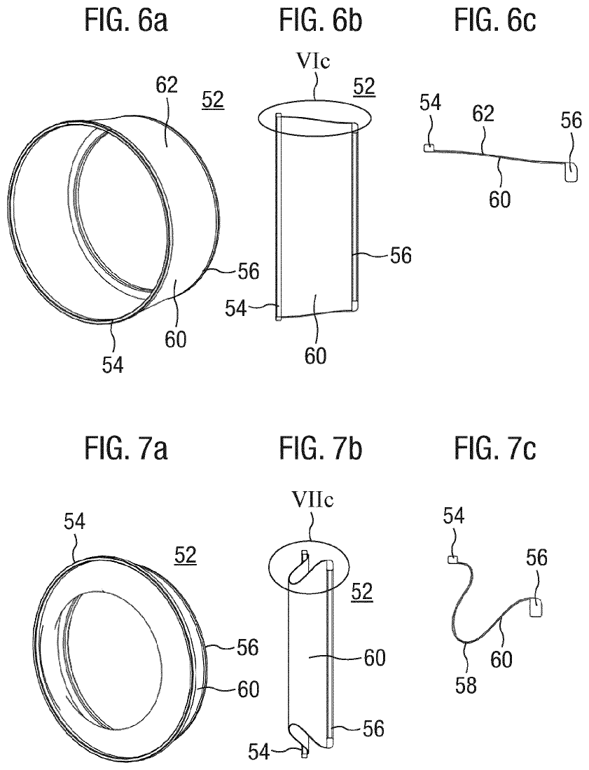

FIG. 6A perspective view (FIG. 6a) and side view (FIG. 6b) of a known “OptraGate®” stringer available on the market, and a section of a longitudinal section (FIG. 6c),

FIG. 7 a perspective view (FIG. 7a) and a side view (FIG. 7b) of the “OptraGate®” stringer in the inserted state, as well as a section of the longitudinal view (FIG. 7c),

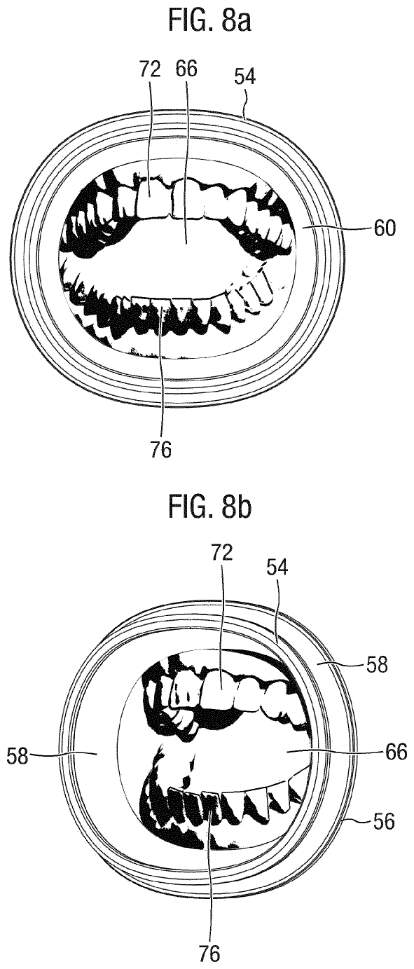

FIG. 8 Detail of the patient's mouth with the cheek retractor “Optra Gate®” in place in front (FIG. 8a) and perspective view (FIG. 8b),

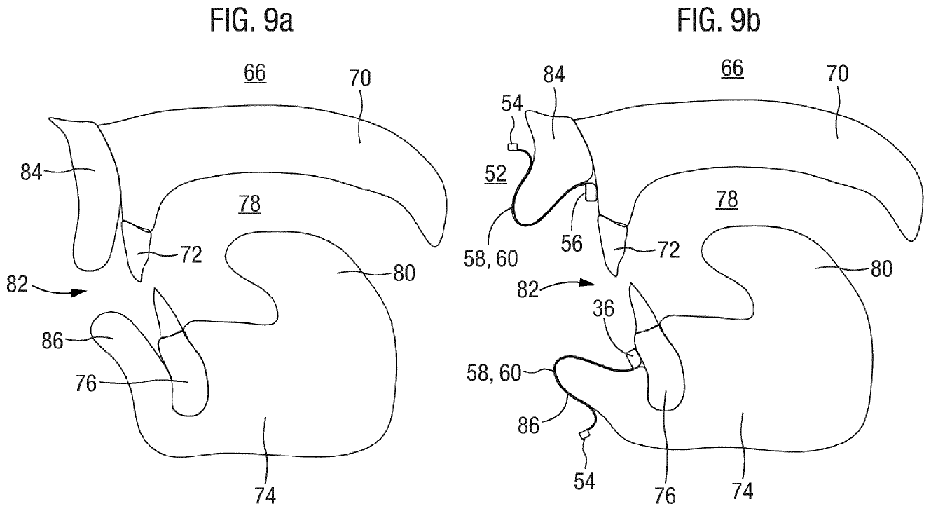

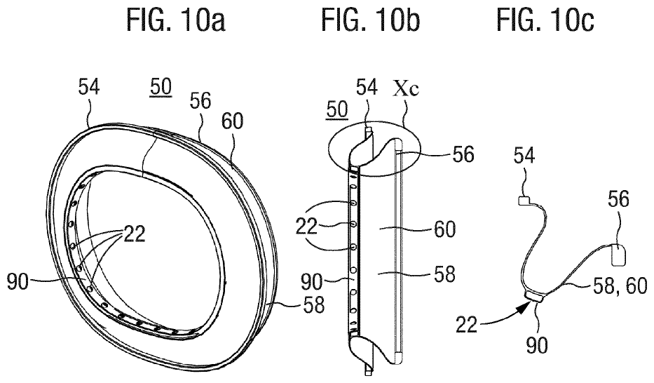

FIG. 9 a section of the jaw region of a patient in longitudinal section without (FIG. 9a) and with (FIG. 9b) the “OptraGate®” cheek retractor in place, FIG. 10A cheek holder further formed according to the invention on the basis of the cheek holder according to FIG. 6, 7 in inserted state in perspective view (FIG. 10a) and lateral view (FIG. 10b), as well as sectional view in longitudinal section (FIG. 10c),

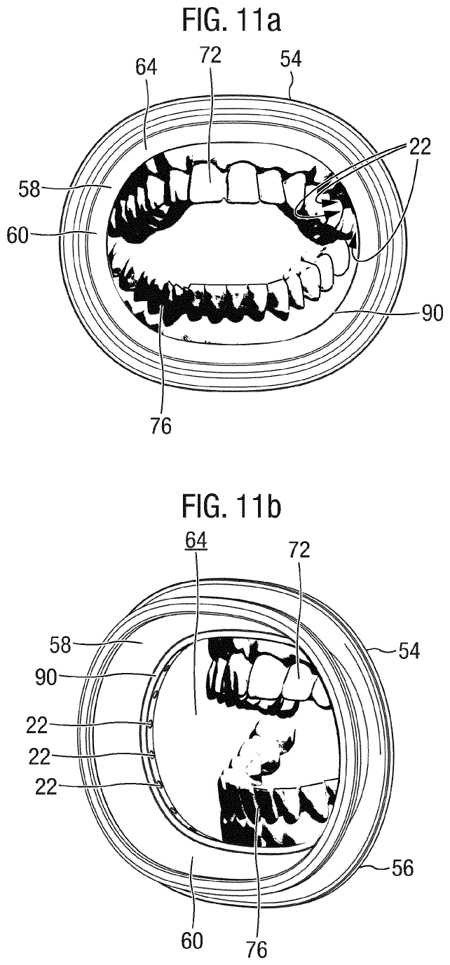

FIG. 11 a sectional view of the patient's mouth with inserted cheek retractor formed according to the invention in front view (FIG. 11a) and perspective view (FIG. 11 b),

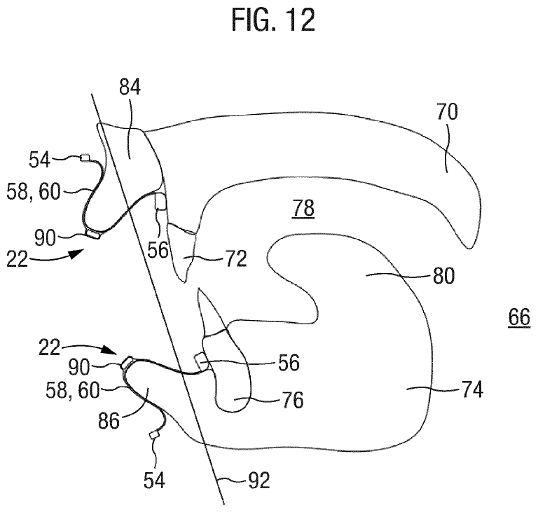

FIG. 12 a sectional view of the jaw region of a patient in longitudinal section with the cheek retractor inserted,

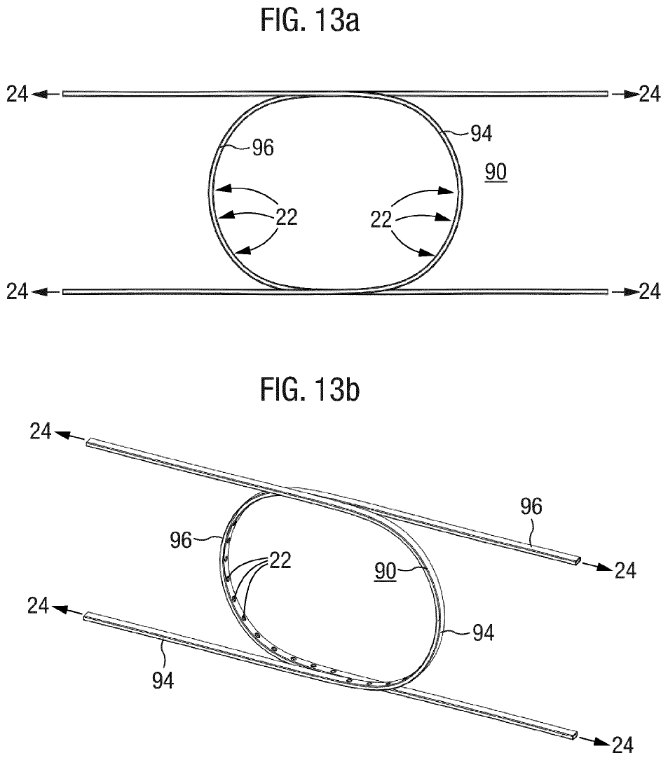

FIG. 13 a tubing system to provide a suction channel,

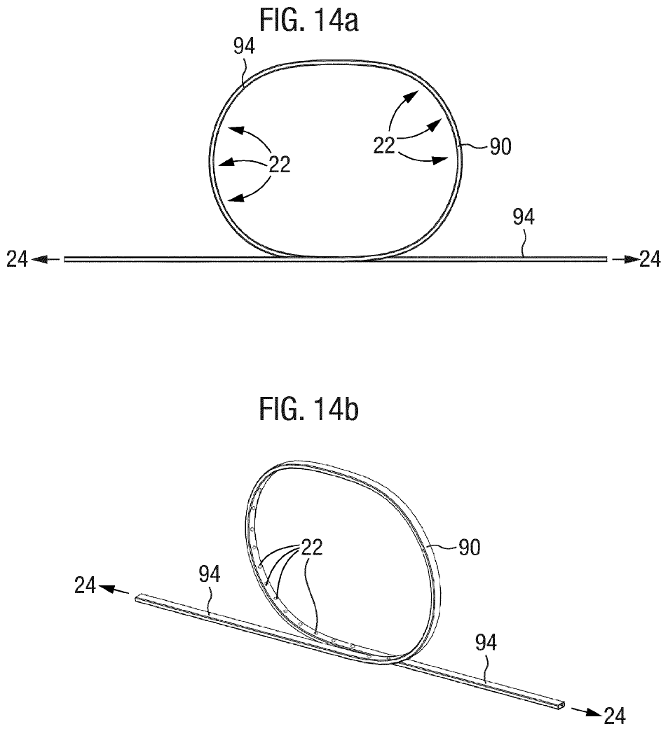

FIG. 14 another tubing system to provide a suction channel,

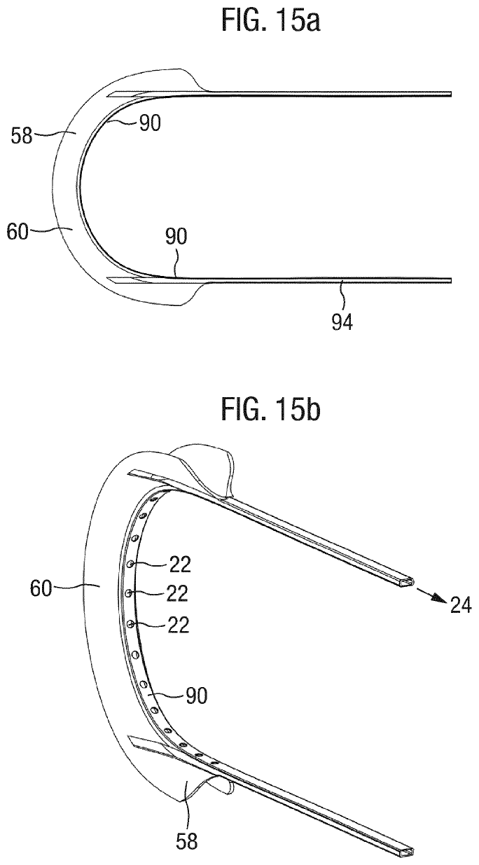

FIG. 15 a frontal (FIG. 15a) and perspective (FIG. 15b) view of a hose system configured as a resilient support structure for a stringer, and

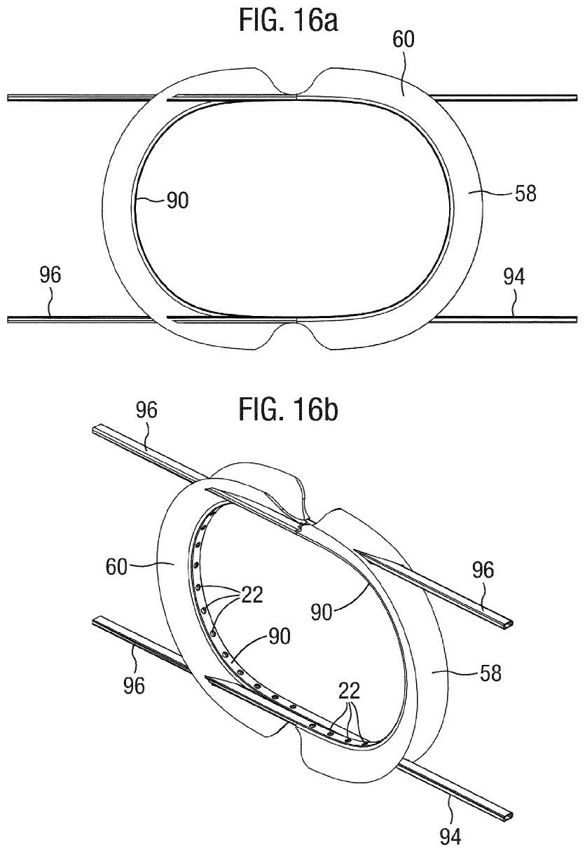

FIG. 16 an alternative embodiment of a tubing system configured as a resilient support structure for a stringer in frontal (FIG. 16a) and perspective (FIG. 16b) views.

Identical parts are marked with the same reference signs in all figures.

The cheek retractor 1 shown in FIG. 1, which is of conventional design, is commonly used in the oral cavity of a patient as part of a treatment to improve access to the treatment in the oral cavity. Such cheek retractor 1 may be used in the corner of the patient's mouth and/or other areas of the patient's cheek and lip to hold them off to increase access into the oral cavity. For this purpose, the cheek retainer 1 comprises a lip retaining shell 2, also referred to as a cheek attachment, which in the embodiment shown is designed in the manner of a semi circular profile. A part of the lip, for example in the corner of the mouth, can be inserted into this lip retainer shell 2 during treatment. For this purpose, the lip retaining shell 2 in the embodiment shown is stretched in a semi-circular shape so that it can be inserted particularly well into a corner of the mouth, protects the lip and pulls the cheek away with traction on an integrally formed cheek retaining handle 4 to increase access to the oral cavity. The patient's lip is thereby partially enclosed by the lip retainer shell 2 to prevent it from slipping away. The lip support 6 of the lip support shell 2, into which the lip is inserted and by which the lip is partially enclosed to ensure a better hold, is provided on the concave side of the lip support shell 2. The side opposite the lip pen support 6 with respect to the lip retaining shell 2, as indicated by the arrow 8, points in the direction into the oral cavity. However, in the case of this type of cheek retractor 1 (simple cheek retractor), it is disadvantageous that it must be held with one hand during treatment.

In contrast, to avoid the need to use a hand to hold the cheek, a likewise conventional cheek holder 10 of double-sided design can also be used, as shown in FIG. 2. This is characterized by the fact that it comprises two lip retaining shells 2, each of which is arranged at the end on a common connector element 12. The two lip retaining shells 2 are inserted into the left and right corners of the patient's mouth during treatment. One of the functions of the connector element 12 is to spread the two cheek attachments away from each other and thus provide the largest possible mouth opening with very good access to the oral cavity. Such double-sided cheek retractors 10, also referred to as double cheek retractors, are particularly useful for PZR, as this therapy can be performed by a single assistant with the appropriate training, as both hands are available for the therapy. However, the double cheek retractors 10 are also used for other therapies.

Based on these known cheek holders 1, 10 according to FIGS. 1, 2, which are to be regarded as state of the art, cheek holders 20 designed according to the invention will now be explained in more detail below. These have in common that they can each be connected to a suction system for aerosols in order to increase the safety of the treating personnel or other persons in the vicinity, wherein a number of their respective lip holding shells 2 are provided in the vicinity of the respective lip contour with a number of suction openings 22 intended for connection to the suction system.

Suction, particularly of aerosols, in the immediate vicinity of the lip pens is ideal for preventing aerosols from escaping from the oral cavity during treatment. It is particularly advantageous if the suction is distributed at least almost constantly over the entire length of the lips. In this way, a relatively constant suction flow is achieved at the outer edge of the oral cavity, which results in an air flow relatively centrally in the oral cavity opening in the direction of the oral cavity. This counteracts the direction of movement of the aerosols leaving the oral cavity, so that they are slowed down and can be captured by the suction. In this way, it can be avoided that the aerosols leave the oral cavity. In a very simple embodiment of the invention, such a suction device in the form of the suction openings 22 is arranged along the lips on at least one lip holding shell 2 of a single- or double-sided cheek holder. The actual suction system 24 connected to the suction openings 22 can comprise, for example, a pipe or hose system 26 connected to the suction openings 22 and shown only schematically in the figure, via which air as well as the aerosols can be sucked in via the suction openings 22 as well, and which in turn is connected to a suitably selected suction pump 28.

A unilaterally designed cheek holder 20 in a first embodiment of the invention is shown in FIG. 3. In this embodiment, the suction is integrated into the cheek holder handle 30 of the cheek holder 20. As can be seen from FIGS. 3a, 3b, the suction holes 22 are made in the lip retainer shell 2 in positions along the expected t lip contour. To provide the suction system, the cheek holder handle 30 is hollow so that the cavity 32 inside forms the suction associated with the suction holes 22. The suction holes 22 in the lip retainer 2 thereby point in the direction of the oral cavity. In the illustrated embodiment, the cheek holder 20 with integrated suction is made in two parts, with one of the two parts being shown in FIG. 3b in the form of a sectional view. The cavity 32 formed allows air, liquids, solids and/or aerosols to be sucked in via the suction openings 22 and then transported away through the cheek holder handle 22 and a suction connection 34 arranged at the end of the cheek holder. The suction connection 34 can in turn be connected to the external suction device, i.e. in particular the suction pump 28, and for this purpose preferably has a standard connection 36 for dental units or dental chairs which can be connected to the hose system 26 for contacting the suction device. In this way, the cheek holder 20 with integrated suction can be connected to any available suction connection of dental units or to another suction system for dental applications.

In FIG. 4, on the other hand, a double-sided cheek holder 40 is shown in a further embodiment of the invention. This design corresponds essentially to the design of the double cheek holder 10 shown in FIG. 2, with the modification that here too the lip retaining shells 2 are provided with suction holes 22 and the connector element 12 is hollow to form a suction channel, so that this cheek holder 40 is also designed with integrated suction. Here, the two lip retaining shells 2 with suction are thus connected to each other via a cheek attachment connector 42 with an integrated cavity system 44. The extracted media are transported via the cavity system 44 to the extraction connection 34, from where they are disposed of via a hose and an extraction unit.

The geometric shape of the suction openings 22 can be designed differently and, in particular, suitably selected adapted to a particular treatment purpose. In FIGS. 3 and 4, the suction openings 22 are shown as a rectangle. However, they may also be round, square, oval, a polygon or a combination of at least two of these shapes. It may also be useful to place a line or other readily mentioned geometric shape of small openings next to each other, for example a line with round openings, which prevent too large particles or elements from being sucked in.

In the design of the suction system as a double cheek holder 40 with integrated suction system, it is expedient and considered to be independently inventive to provide the section of the oral cavity opening or the section of the lips as far as possible in its entirety or fully permanently with a suction system in order to achieve a particularly high efficiency of the suction. The “lip section” is defined here as the total section formed by the section resulting from the upper lip and the section resulting from the lower lip. Due to the very individual lip sections of different patients, it is not always possible to provide the entire lip section with suction openings. However, at least 25%, preferably 50% and particularly preferably 75% of the length of the lips is provided with suction or with suction openings 22 placed in the vicinity, which is particularly preferred and is regarded as an independent invention.

Alternatively, the cheek retractor according to the invention can also be provided as a system comprising more than two lip retractor shells 2 with and in some cases without integrated suction. This could prove to be particularly favorable with regard to handling on the patient. It is also possible to connect the cheek attachments to a line system which also has suction openings, air outlet openings, distance sensors and or glove holder ribs. In addition, the exhaust port can also be attached directly to one of the cheek extensions or to the piping system that may be used. The claimed stringer holder with integrated suction system may be listed in one piece or in multiple pieces. In this case, the suction system can also be designed to be separately attachable to the stringer holder.

In a further particularly preferred variant, the cheek attachment 2 is designed along the entire length of the lips. This means that the cheek line is closed along the length of the lips. However, it can also be interrupted at one or more points along the length of the lips.

If the suction power is very high, there is the theoretical possibility that the gloves used by the treating personnel could be sucked in via the suction openings 22 and thus hinder the personnel in their handling. Although the gloves usually fit very snugly on the hands, suction may still occur. This is a disturbing and unpleasant side effect for the personnel performing the therapy. To avoid this effect or to reduce this inconvenience, in a particularly preferred embodiment, which is also considered to be independently inventive, spacers or spacer ribs 46 are provided in the vicinity of the suction holes 22. The se result that when the gloves fit very snugly on the hands, the gloves cannot have direct contact with the intake holes 22.

One such embodiment of a lip retainer shell 2 with integrated suction and with a number of integrally formed retainer ribs 46 is shown in FIG. 5. Here, the glove-retaining ribs 46 are each arranged between two adjacent suction openings so that avoidance or at least reduction of contact of the gloves with the suction openings 22 is achieved in a particularly reliable manner. The design of the glove restraint shown in FIG. 5 thereby only shows the inne re shell of a cheek attachment 20, 40 with integrated suction, and it represents only one example of such a design. It is also possible to use straight or curved ribs or otherwise shaped glove restraints. Furthermore, the function intended hereby, i.e. the avoidance of direct surface contact of the fingers or gloves with the actual suction openings 22, can also be achieved by the suction openings 22 themselves being arranged in a recess within a spatially lowered contour, for example a groove or depression. In particular, they may be located in the area embossed in the lip retaining shell 2, which is at least twice as large in area as the area of the suction openings 22 themselves. For all embodiments with the objective of glove retention, it is desirable that the front edges of the protective device protrude at least 1.0 mm, preferably 2.0 mm, and particularly preferably 3.0 mm above the surface of the respective suction opening 22, or that the respective suction opening 22 is positioned lowered relative to the “free surface” of the lip retaining shell 2 by the corresponding amounts.

The cheek retractors 20 with integrated suction and, in particular, the double cheek retractors 40 with integrated suction and optional glove retractor ribs can work particularly efficiently if the suction line or the suction volume, if possible, is at least as high as the volume of liquids, gases and solids introduced into the oral cavity, usually in the form of air, water and powder (for a PZR), when added to the suction line or the suction volume of the additional suction instruments that may be introduced. In addition, the patient's exhalation volume can also be included in the calculation of the minimum necessary suction volume. In most cases, however, the patient closes the pharynx with the tongue and breathes through the nose during the introduction of liquids, gases and/or solids (e.g. cooling during grinding, air-powder-water spray [PZR], air-water mixture, air, etc.) in order to avoid swallowing the media introduced. Consequently, the necessary aspiration volume should be at least 120%, preferably at least 150%, and in a particularly preferred embodiment 200% of the introduction volume. The corresponding volumes can be determined by the dental unit via measurements on its own unit or on additionally used units and in this way control or regulate the suction volume. This can also be done by an external unit. The suction system 24 and in particular the suction pump 28 assigned to it are designed for a suction capacity of at least 750 l/min, so that the above criteria are easily met.

In order to handle more massive media, which may not even be captured by the suction flow when they are ejected from the oral cavity, just as reliably, an advantageous and independently inventive design is to deflect them in their resulting trajectory and move them in the direction of the suction flow so that they can be captured and suctioned off by it. For this purpose, the cheek projections should have, on the one hand, the suction openings 22 already mentioned and, on the other hand, an air supply system which, by means of injected air, can deflect the exhaust gas stream flowing out of the mouth cavity toward the edge regions of the mouth opening and thus toward the suction openings positioned there. For this purpose, in addition to the intake openings 22, a number of air outflow openings connected to an overpressure system on the inlet side are arranged on the respective lip pen retaining shell 2. In a particularly preferred embodiment, the ensemble of intake openings 22 and discharge openings is designed in such a way that the total area of the discharge openings is smaller than the total area of the intake openings 22, in particular in order to achieve a high air discharge velocity.

In simple embodiments, the suction openings 22 are arranged either along the upper lip, along the lower lip, along the lip of the second and third quadran tents or of the first and fourth quadrants. It is also possible to choose an arrangement in the lip regions of the first and third or second and fourth quadrants. The air outlet openings are in each case located opposite one another. In a preferred embodiment, the air outlet openings are located between the areas of the intake openings 22. In addition, the air outlet openings are additionally positioned opposite the intake openings 22 with respect to the course of the lips on the lip section. In this way, it can be achieved that when instruments, fingers or hands are inserted, a partial area of the oral cavity is not exclusively subjected to air pressure, which would counteract the original basic idea of preventing aerosols from escaping from the oral cavity. For such a design variant, it is advantageous to integrate an overpressure line system in or on the cheeks holder 20 or double cheek holder 30 in addition to the suction line system and to provide a connection for it. The resulting air outlet volume should advantageously be included in the calculation of the necessary extraction volume.

During treatment or therapy, instruments, fingers and or hands must be introduced into the oral cavity. Regardless of the design variant used and already described (suction with or without air outlet, cheek holder according to FIG. 1 or FIG. 2 etc.), the introduction of instruments, fingers and/or hands into the oral cavity will impair the suction efficiency and may not be optimal in all accesses to the oral cavity that are still open. To optimize for this, ab standing sensors can be mounted in the lip retaining shells 2 along the length of the lips, which detect the position of the instruments, fingers and/or hands protruding into the oral cavity. Based on the distance or position data determined from this, the suction power or suction volume can be calculated and controlled or regulated for each area still open to the oral cavity, also in combination with the determination of the optimum air outlet. For optimale efficiency, it is then also advantageous that the suction openings 22 and the air outlets are divided into several groups, which should then also be individually controllable at.

With regard to the problem of gloves being sucked in or media being sealed and possibly splashed when air outlet openings are closed, an overpressure/underpressure measurement can also take place in the respective suction lines or pressure lines, which adjust the suction or air outlet performance accordingly if necessary.

An alternative, particularly preferred embodiment of a cheek retractor 50 according to the invention is explained in more detail below with reference to and as an inventive further development of a known cheek retractor 52 already available on the market under the product designation “OptraGate®”.

The known cheek retractor 52 “OptraGate®” is shown in FIG. 6 in a ready-for-sale condition in perspective (FIG. 6a) and lateral view (FIG. 6b) as well as in a sectional longitudinal view (FIG. 6c). It includes an outer or extra-oral retaining or support ring 54 and an inner or intra-oral retaining or support ring 56, both of which are made of elastic material and are correspondingly deformable. The support rings 54, 56 are mechanically connected to each other via a deformable membrane 60 forming the lip retaining shell 58. In particular, the support rings 54, 56 are thereby made of a harder plastic, such as an ABS, compared to the diaphragm 60 and are of a resilient design. As can be seen from the sectional view in FIG. 6c, the diaphragm 60 in the unloaded state has a side wall 62 that is almost straight in the longitudinal direction.

For use during treatment of a patient, the cheek retractor 52 is first inserted into the patient's mouth with the support rings 54, 56 temporarily suitably deformed. In this process, as is evident in FIG. 7 in perspective (FIG. 7a) and lateral view (FIG. 7b) as well as in detail in longitudinal section (FIG. 7c) and most particularly in FIG. 8 by the detail of the patient's mouth 64, the inner support ring 56 is positioned behind the patient's lip, where, on the other hand, the outer support ring 54 remains outside the lip contour. Due to the elastic restoring forces and the resilient design, the support rings 54, 56 resume their original contour as far as possible after insertion, so that they locally fix the membrane 60. The membrane 60 thereby deforms in the longitudinal direction and encompasses the patient's lip, clearly forming the lip retaining shell 58.

For further clarification, FIG. 9 shows a section of the jaw region 66 of a patient in longitudinal section without (FIG. 9a) and with (FIG. 9b) the cheek retractor 52 inserted. Shown are the patient's maxilla 70 with upper anterior tooth 72 and mandible 74 with lower anterior tooth 76, which together form oral cavity 78. The tongue 80 is also located in the oral cavity 78. The mouth opening 82, through which exhalation may take place, is bounded by the upper lip 84 and the lower lip 86, which in their entirety fully enclose the mouth opening 82 at all times. In the illustration shown in FIG. 9b, with the cheek retainer 52 inserted, it is clear how the membrane 60 encompasses the upper and lower lips 84, 86 to form the lip retainer shell 58. It can also be clearly seen that as a result of the inserted cheek retainer 52, both the upper and lower lips 84, 86 are curved forward, away from the oral cavity 78, to optimize oral accessibility.

Based on this known cheek retractor 52, the cheek retractor 50 further developed in accordance with the invention is explained in more detail below. As can be seen from the illustration according to FIG. 10 in the inserted state in perspective view (FIG. 10a) and lateral view (FIG. 10b) as well as in a sectional view in longitudinal section (FIG. 10c), the cheek holder 50 further formed according to this embodiment example of the invention has on its membrane 60 forming the lip retaining shell 58 a suction channel 90 attached thereto, for example formed on, glued on, vulcanized on or welded on. The suction channel 90 is provided with suction openings 22 and, on the other hand, is connected to the suction system 24 on the gas side via the hose system 26 in a manner analogous to the embodiments already described above and is connected via the latter to the suction pump 28 at.

As can be seen particularly clearly in the illustration of the patient's mouth 64 with the cheek retractor 50 inserted in accordance with the preferred embodiment in FIG. 11, in this embodiment in particular the suction channel 90 can be guided completely around the mouth opening 82 and thus completely along the lip section defined by the upper lip 84 and the lower lip 86. This ensures that in this embodiment example the entire lip section is provided with suction openings 22.

In FIG. 12, the patient's jaw region 66 is shown with the cheek retractor 50 inserted according to a particularly preferred embodiment. It is clearly visible here, among other things, that in this embodiment in particular the suction openings 22 brought to in the suction channel 90 are spatially positioned directly at the mouth opening 82 defined by the lips 84, 86. In particular, the desired criterion that the suction openings 22 should be positioned particularly close, i.e. at most 50 mm, preferably at most 25 mm and in particular at most 10 mm, to the separating plane representing the position of the mouth opening 82 between the so-called “intraoral” or inner region of the oral cavity 78 and the so-called “extraoral” or outer region of the oral cavity 78 is thus easily fulfilled. In FIG. 12, this parting plane is represented by line 92.

As mentioned, the suction channel 90 may be formed on the lip retaining shell 58 of the cheek holder 50. However, in another embodiment considered to be independently inventive, the suction channel 90 is formed by a number of pieces of tubing 94, 96, preferably made of a plastic material commonly used in the dental field, such as PVC, latex, ABS or silicone. To form a contour covering the entire lip section, a combination of two or more suitably overlapping pieces of tubing 94, 96 can be provided, as shown in FIG. 13 in frontal (FIG. 13a) and perspective (FIG. 13b), which are suitably attached, for example welded, to the membrane 60 forming the lip retaining shell 58 and are connected on the gas side to the suction system 24 via the tubing system 26 and are connected via the latter to the suction pump 28. Alternatively, in this case, the suction channel 90 can of course also be formed by a single piece of tubing 94, as shown in FIG. 14 in frontal (FIG. 14a) and perspective (FIG. 14b) view. In this variant, the piece of tubing 94 is guided in the manner of a closed loop to form a contour covering the entire lip section and is suitably attached, for example welded, to the membrane 60 forming the lip retaining shell 58, and is connected on the gas side to the suction system 24 via the tubing system 26 and connected to the suction pump 28 via the latter.

In a very particularly preferred embodiment, the hose or tube pieces 94, 96 forming the suction channel 90 are, in terms of functionality corresponding to the above-described embodiment of the retaining or support rings 54, 56, made of a harder, in particular resiliently deformable, material such as an ABS compared to the material of the membrane 60. This means that they can be temporarily deformed when the cheek retractor 50 modified in this way is inserted into the patient's mouth, but subsequently resume at least almost their original shape due to the resilient design and can thus also contribute to stabilization and secure positioning of the cheek retractor 50 in the patient's mouth in the manner of a dual function. A tube or hose system designed in this way as a resilient support structure for the cheek retractor 50 is shown in FIG. 15 in frontal (FIG. 15a) and perspective (FIG. 15b) view; an alternative embodiment thereof is shown in FIG. 16.

### LIST OF REFERENCE SIGNS

1 Cheek holder in single-sided design

2 Lip retainer

4 Cheek holder handle

6 Lip support

8 Arrow

10 Cheek holder in double-sided design

12 Vonnector element

20 cheek holder

22 Suction opening

24 Suction system

26 Hose system

28 Suction pump

30 cheek holder handle

32 Cavity

34 Suction connection

36 Standard connection

40 Cheek holder

42 Joining connector

44 Cavity system

46 Holding rib

50 cheek holder

52 Known “OptraGate®” stringer holder

54, 56 Support ring

58 Lip retainer

60 Membrane

62 Sidewall

64 Patient mouth

66 Jaw area

70 Upper jaw

72 Upper anterior tooth

74 Lower jaw

76 Lower anterior tooth

78 Mouth cavity

80 Tongue

82 Mouth opening

84 Upper lip

86 Lower lip

90 Suction channel

92 Line

94, 96 Piece of hose

1.-5. (canceled)

6. A cheek retainer for keeping a patient's mouth open during a treatment in an oral or pharyngeal region or a dental treatment, comprising:
a lip retainer shell which completely receives the patient's lips along the entire lip section or lip contour and on which a number of suction openings connected to a suction system are arranged, and wherein at least 50% of the lip section is provided with suction openings along the lip section.

7. The cheek retainer according to claim 6, wherein at least 75% of the lip section is provided with suction openings along the lip section.

8. The cheek retainer according to claim 6, wherein the suction openings are positioned at most 25 mm offset from a parting plane between inner and outer regions of the patient's oral cavity.

9. The cheek retainer according to claim 6, wherein the suction openings are positioned at most 20 mm offset from a parting plane between inner and outer regions of the patient's oral cavity.

10. The cheek retainer according to claim 6, wherein the suction openings are positioned at most 10 mm offset from a parting plane between inner and outer regions of the patient's oral cavity.

11. The cheek retainer according to claim 6, wherein the or each lip retainer shell is provided with a number of retaining ribs.

12. The cheek retainer according to claim 6, wherein a suction power of the suction system is selected such that a suctioned volume flow is at least 125% of a volume flow of media supplied during treatment.

13. The cheek retainer according to claim 6, wherein a suction power of the suction system is selected such that a suctioned volume flow is at least 150% of a volume flow of media supplied during treatment.

14. The cheek retainer according to claim 6, wherein a suction power of the suction system is selected such that a suctioned volume flow is at least 200% of a volume flow of media supplied during treatment.

15. The cheek retainer according to claim 6, further comprising:
an outer retaining or supporting ring; and
an inner retaining or supporting ring; and
wherein both the outer retaining or supporting ring and the inner retaining or supporting ring are made of elastic material and are correspondingly deformable and mechanically connected to one another via a deformable membrane forming the lip retainer shell.

16. The cheek retainer according to claim 15, wherein the deformable membrane includes a suction channel in communication with the suction openings.
